(19) United States
(12) Patent Application Publication
(10) Pub. No.: US 2008/0172512 A1
(43) Pub. Date: Jul. 17, 2008

(54) NETWORK CARD WITH BUILT-IN CARD READER

(75) Inventors: BIAN WU, Shenzhen (CN); XIAO-LIN GAN, Shenzhen (CN); YU-KUANG HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., ShenZhen City (CN); HON HAI PRECISION INDUSTRY CO., LTD., Tu-Cheng (TW)

(21) Appl. No.: 11/838,901

(22) Filed: Aug. 15, 2007

(30) Foreign Application Priority Data
Jan. 12, 2007 (CN) 200710200047.2

(51) Int. Cl. G06F 13/00

(52) U.S. Cl. 710/301

(57) ABSTRACT

An exemplary wireless network card includes a wireless network card controller, a bus interface having two input ports and one output port, and a card reader controller, wherein the wireless network card controller and the card reader controller are connected to the inputs port of the bus interface respectively, and the output port of the bus interface is connected to an electronic equipment. The electronic equipment can be linked to a net via the wireless network card controller, and also can receive data transmitted from the card reader read from a memory card.

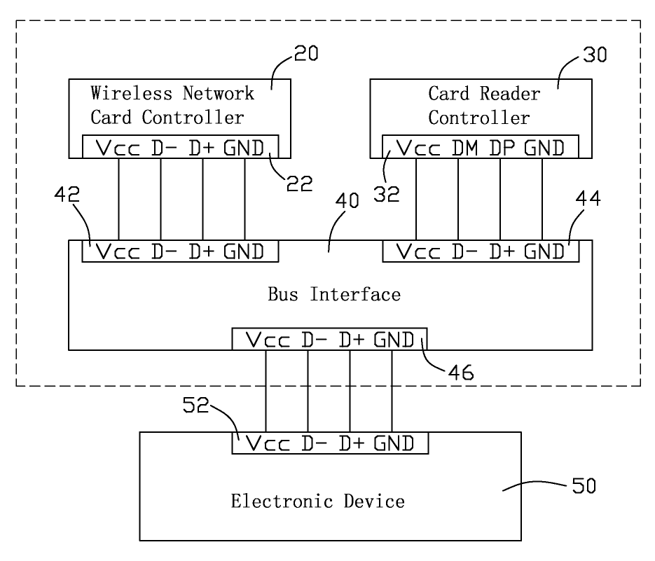

### BACKGROUND

1. Field of the Invention

The present invention relates to network cards, and particularly to a network card having a built-in card reader.

2. Description of Related Art

A network card, network adapter, or network interface card (NIC) is a piece of computer hardware designed to allow computers to communicate over a computer network. It is both an OSI layer 1 (physical layer) and a layer 2 (data link layer) device, as it provides physical access to a networking medium and provides a low-level addressing system through the use of MAC addresses. It allows users to communicate with each other either by using cables or wirelessly.

A card reader is a device used for communication with a smart card or a flash memory card. Some personal computers and notebook computers have a built-in card reader. Therefore, the card reader will occupy space in the computer.

### SUMMARY

An exemplary wireless network card includes a wireless network card controller, a bus interface having two input ports and one output port, and a card reader controller, wherein the wireless network card controller and the card reader controller are connected to the input ports of the bus interface respectively, and the output port of the bus interface is connected to an electronic device.

Other advantages and novel features will become more apparent from the following detailed description when taken in conjunction with the accompanying drawing, in which:

### BRIEF DESCRIPTION OF THE DRAWINGS

The drawing is a circuit diagram of one embodiment of a wireless network card in accordance with the present invention.

### DETAILED DESCRIPTION

Referring to the drawing, a wireless network card in accordance with an embodiment of the present invention includes a wireless network card controller 20, a card reader controller 30, and a bus interface 40 having two input ports 42 and 44 connected to the wireless network card controller 20 and the card reader controller 30 respectively, and one output port 46 connected to a corresponding port 52 of an electronic device 50 such as a personal computer or a notebook computer.

The wireless network card controller 20 includes an output port 22 having a power terminal Vcc, a first data terminal D−, a second data terminal D+, and a ground terminal GND. The card reader controller 30 includes an output port 32 having a power terminal Vcc, a first data terminal DM, a second data terminal DP, and a ground terminal GND. The bus interface 40 is a USB hub, therefore each of the input ports 42 and 44 and the output port 46 has a power terminal Vcc, a first data terminal D−, a second data terminal D+, and a ground terminal GND. The port 52 of the electronic device 50 is also a USB port having a power terminal Vcc, a first data terminal D−, a second data terminal D+, and a ground terminal GND.

The power terminal Vcc, first data terminal D−, second data terminal D+, and ground terminal GND of the output port 22 of the wireless network card controller 20 are connected to the corresponding terminals of the input port 42 of the bus interface 40 respectively. The power terminal Vcc, first data terminal DM, second data terminal DP, and ground terminal GND of the output port 32 of the card reader 30 are connected to the corresponding terminals of the input port 44 of the bus interface 40 respectively.

Therefore, the electronic device 50 can be linked to a network via the wireless network card controller 20, and can also receive data transmitted from the card reader 30 read from a memory card.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A wireless network card comprising: a wireless network card controller, a bus interface having two input ports and one output port, and a card reader controller, wherein the wireless network card controller and the card reader controller are connected to the input ports of the bus interface respectively, and the output port of the bus interface is connected to an electronic device.

2. The wireless network card as claimed in claim 1, wherein the wireless network card controller and the card reader controller transmit data in a same mode.

3. The wireless network card as claimed in claim 2, wherein the bus interface is a USB hub.

4. The wireless network card as claimed in claim 3, wherein the electronic device is a computer.

5. A wireless network card comprising:
a bus interface having two input ports and one output port,
a wireless network card controller coupled to one of the input ports of the bus interface, and
a built-in card reader controller coupled to the other one of the input ports of the bus interface,
wherein the output port of the bus interface is configured to couple to an electronic device such that the wireless net work card gets power from the electronic device and communicates with the electronic device.

6. The wireless network card as claimed in claim 5, wherein the input ports and output ports are USB ports.
